(19) United States
(12) Patent Application Publication
(10) Pub. No.: US 2011/0171590 A1
(43) Pub. Date: Jul. 14, 2011

(54) DEVICE FOR HEATING ROD-TYPE WORK PIECES

(75) Inventors: Uwe Guenter, Gaienhofen (DE); Stefan Beer, Menden (DE)

(73) Assignee: I.A.S. INDUKTIONS-ANLAGEN + SERVICE GMBH & CO. KG, Iserlohn (DE)

(21) Appl. No.: 12/998,130

(22) PCT Filed: Sep. 5, 2009
(86) PCT No.: PCT/EP2009/006462

§ 371 Date: Mar. 21, 2011

(30) Foreign Application Priority Data
Sep. 22, 2008 (DE) 20 2008 012 597.9

(51) Int. Cl. C21D 9/00; F27B 19/04

(52) U.S. Cl. 432/92; 432/94

(57) ABSTRACT

The invention relates to a device for heating rod-type, metallic work pieces, comprising two heating modules that are switched one behind the other, which are coupled with one another by way of a control module, so that a continuous heating chamber is formed, whereby the first heating module is formed by a gas oven (1), and the second heating module is formed by an induction oven (2).

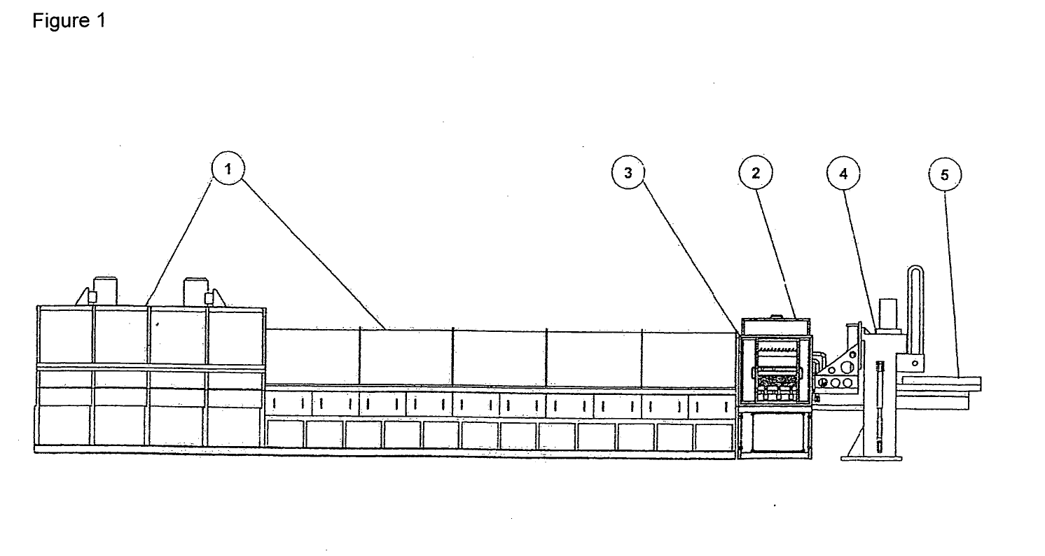

The invention relates to a device for heating rod-type, electrically conductive work pieces, in accordance with claim 1.

The process technology requirements for temperature management in heating aluminum bolts have constantly increased in recent years. The correct bolt temperature is of central importance for efficient and high-quality extrusion operation. The problems of the heating process are generally divided up into two tasks nowadays: heating the bolt to pressing temperature and producing an axial block temperature (taper) that compensates the heating during the forming process, in such a manner that an isothermal pressing process is achieved. According to the present state of the art, essentially three alternatives are available for heating the bolts: fuel-heated heating with integrated heating shears, bolt heating with induction systems, and combined bolt heating with quick-heating gas ovens and induction systems.

In fuel-heated heating, a temperature profile can be produced in the sheared-off bolt, using a head heating system. However, here it must be noted that a flexible change in the reference value, within a short period of time, cannot be achieved in practice. In the case of heating using induction systems, the so-called high-power oven with multiple layers of windings and with multiple axially disposed heating zones is the state of the art. This type of system, however, has the disadvantage that the throughput decreases as the block length becomes shorter, because of the power density distribution.

In the combined bolt heating with quick-heating gas ovens and induction systems, first basic heating takes place with a conventional multi-zone gas oven, while the defined precise adjustment of the temperature takes place with a multi-zone induction oven. Fundamentally, the process chain is structured as follows in this heating variant:

The aluminum rods are stored in a block magazine, by alloy type. In accordance with the process program, the aluminum rods are preheated in the gas oven and adapted to the required block length using heat block shears. The bolt that has been heated and sheared off in this way is removed from the gas oven using conventional handling means, and passed to an induction oven. Here, precise adjustment to the desired block temperature, with axial temperature gradients, takes place. The requirements regarding the gas oven are lower here, because here, the gas oven only has to supply a basic temperature to allow hot shearing of the aluminum block.

It is a disadvantage of the aforementioned heating devices that they are efficient only within limits, because of the great amount of energy that must be used. While it was possible to lower the energy consumption by means of the principle of pre-heating of the rod-type goods in the gas oven, with subsequent shearing and subsequent heating of the sheared-off bolt in an induction oven, the transfer of the pre-heated bolt proves to be problematic. For one thing, uncontrolled cooling of the bolt takes place here, and for another, the production process is very complicated, because of the charging of the individual ovens.

This is where the invention wants to provide a remedy. The invention is based on the task of creating a device for heating rod-type, electrically conductive work pieces, which allows continuously controlled heating of the rod material, and in which the handling effort is minimized. According to the invention, this task is accomplished in that the device comprises two heating modules that are switched one behind the other and are coupled with one another by way of a control module, so that a continuous heating chamber is formed, whereby the first heating module is formed by a gas oven, and the second heating module is formed by an induction oven.

With the invention, a device for heating rod-type, electrically conductive work pieces is created, which allows continuously controlled heating of the rod material, and in which the handling effort is minimized. The rod material is pre-heated within the gas oven, and—without a further handling process being required—conveyed into the second heating module, where a defined rod region has an axial temperature profile applied to it by means of an induction oven. This rod region can subsequently be hung off by way of a cutting device.

In a further development of the invention, the induction oven has at least two heating zones that can be regulated independent of one another. In this way, the possibility of applying a defined axial temperature profile to the bolt is created.

In an embodiment of the invention, a thermal uncoupling module is disposed between the first and the second heating module. In this way, an uncontrollable interaction between the two heating modules is prevented, thereby increasing the ability to control the heating process. Preferably, the uncoupling module is configured in such a manner that a flame flash-over from the first heating module into the second heating module is prevented.

In a further embodiment of the invention, the induction oven is structured in field-distributor-free manner. Since the induction oven of the second heating module is always completely filled as the result of continuous operation, it is not necessary to compensate deviating block lengths, thereby making it possible to eliminate the use of field distributors. In this way, the efficiency of the device is increased.

Preferably, means for cutting a heated work piece to length are disposed on the second heating module. In this way, in-process cutting to length of the rod region having a defined axial temperature profile, with subsequent feed into the pressing operation, is made possible. Preferably, the means for cutting to length are formed by hot shears or a hot saw.

Other further developments and embodiments of the invention are indicated in the remaining dependent claims. An exemplary embodiment of the invention is shown in the drawing and will be described in detail below. The single FIGURE shows a schematic representation of a device for heating rod-type, electrically conductive work pieces.

The device for heating rod-type, electrically conductive work pieces that has been selected as an exemplary embodiment consists essentially of a gas oven 1, which is connected with an induction oven 2 by way of a thermal uncoupling ring 3. The induction oven 2 is followed by hot shears 4 for cutting a bolt 5 to length.

On its side facing away from the induction oven 2, the gas oven 1 is provided with a heat bulkhead—not shown. This heat bulkhead serves to reduce the heat that exits from the oven.

The induction oven 2 is a so-called long induction oven with an integrated taper zone. This oven fundamentally corresponds to the induction oven used in the past, which functions as a pusher-type furnace. The possibility of applying an axial temperature profile to a work piece section is created by means of integration of multiple heating zones, which can be independently regulated, into the run-out zone. Gas oven 1 and induction oven 2 are connected with one another by way of a thermal uncoupling ring 3. The uncoupling ring 3 is structured in such a manner that flame flash-over from the gas oven 1 into the induction oven 2 is prevented. A roller conveyor—not shown—is introduced continuously through the gas oven 1 and the induction oven 2, which allows continuous, non-stop charging of the ovens 1, 2.

Control of the gas oven 1 and of the induction oven 2 takes place by way of a control module—not shown—that controls the process temperatures as a function of the process states of the two ovens 1, 2, in each instance.

On its side that lies opposite the gas oven 1, hot shears 4 are disposed on the induction oven 2. The hot shears 4 allow defined cutting to length of a bolt 5 to which the desired temperature has been applied, from the heated rod-type work piece that is situated in the device.

The device according to the invention links cost-advantageous gas heating as a basic load with a multi-zone, high-power induction oven for the tapering operation, in a continuous heating chamber. By means of designing the gas oven for a basic load operating point, the efficiency of the gas oven lies in an optimized range. The induction oven serves only for applying an axial temperature gradient. Therefore the efficiency of the gas oven lies at about 60%, that of the induction oven at about 66%. Since the induction oven is always filled, and therefore deviating block lengths no longer have to be compensated, field distributors as required in the state of the art are no longer needed. Secondary process times can be reduced by means of shifting process-related heat-through times into the hot shearing or hot sawing cycle. Furthermore, the complicated conveying and handling technology required in the state of the art is eliminated. It is replaced by the conveying device disposed within the device. For example, a conventional charging cradle system can be used. As the result of the significantly shortened transport times, a lower energy loss due to radiation is furthermore brought about. The device according to the invention makes completely controllable automation of the bolt heating during extrusion operation possible.

1. Device for heating rod-type, electrically conductive work pieces, comprising two heating modules that are disposed one directly behind the other, which are coupled with one another by way of a control module, so that a continuous heating chamber is formed, whereby the first heating module is formed by a gas oven (1), and the second heating module is formed by an induction oven (2), wherein the control module controls the process temperatures as a function of the process states of the two ovens, in each instance, and wherein a thermal uncoupling module is disposed between the first and the second heating module, which uncoupling module is configured in such a manner that flame flash-over from the first heating module into the second heating module is prevented, and wherein the induction oven (2) is configured in field-distributor-free manner.

2. Device according to claim 1, wherein the induction oven (2) has at least two heating zones that can be regulated independent of one another.

3-5. (canceled)

6. Device according to claim 1, wherein means for cutting a heated work piece (5) to length are disposed on the second heating module.

7. Device according to claim 6, wherein the means for cutting to length are formed by hot shears (4) or a hot saw.
